(19) United States
(12) Patent Application Publication
(10) Pub. No.: US 2025/0338992 A1
(43) Pub. Date: Nov. 6, 2025

(54) REMOVABLE STEAM WAND FOR A BEVERAGE MAKING MACHINE

(71) Applicant: Joel Moll, Snoqualmie, WA (US)

(72) Inventor: Joel Moll, Snoqualmie, WA (US)

(21) Appl. No.: 18/652,117

(22) Filed: May 1, 2024

(51) Int. Cl. A47J 31/44

(52) U.S. Cl. CPC A47J 31/4489

(57) ABSTRACT

A quick-connect steam wand assembly for steaming beverages and more particularly to a wand that can be easily attached or detached quickly to a beverage/espresso making machine. Wherein the steam wand assembly is formed at least two parts. Wherein the second part attaches to the first part via a spherical bearing or by pair of magnets that allows quick connection or disconnection for effectively cleaning the wand without taking the machine out of commission.

### FIELD OF THE INVENTION

The invention relates to an apparatus for steaming beverages and more particularly to a quick-connect steam wand that can be attached or detached quickly to a beverage/espresso making machine.

### BACKGROUND OF THE INVENTION

Espresso machines are currently well-known types of devices that are used to create espresso beverages in both commercial and home consumer settings. While the term espresso refers to a specific type of brewed drink, many other types of hot drinks are made that include espresso as an ingredient using an espresso machine, such as café latte, cappuccino, macchiato, and many others. Typically, the hot drinks require that the user of the espresso machine prepare the non-espresso ingredients using a device known as a steam wand.

A steam wand is a device that dispenses pressurized hot steam when desired. The hot steam is supplied by a boiler, and dispensation is controlled by a valve. The wand is typically elongate, with steam exhaust ports at a distal tip.

A steam wand is generally an integral part of an espresso machine that is standard equipment on most available espresso machines, though standalone steam wands also exist.

On some espresso machines and other beverage makers, steam wands are used to the texture, warm, and/or blend an additional ingredient for espresso drinks, such as milk, milk substitute, water, syrup, tea concentrate, or other. It is desirable to adjust the steam wand angle and position for different milk texture results, different amounts of milk, user visibility, and user preference.

Commercial coffee houses, for example, which are the primary users of commercial types of espresso machines, must follow a strict regimen of cleaning their espresso machines. Failure to do so can, at best, impede the proper functioning of the espresso machine and, at worst, can foster the growth of bacteria which could be harmful to the consumer. On a less severe, yet especially practical level, an unclean espresso machine may include an oily coffee related residue that can have a deleterious effect on the taste of the espresso beverage being prepared. The espresso beverage derived from a clean espresso machine simply tastes better.

The cleaning regimen typically requires the use of a precise amount of powdered espresso machine detergent, which is specifically made for that purpose.

Further, the cleaning procedure is very complicated for the steam wands as they are attached to the machines. Which will require a person with expertise in effectively cleaning the wand. Still, there are chances that wand will be left with residues in areas that are difficult or impossible to access. Alternatively, the earlier versions just allow removal through disassembly of wand/valve assembly which is still complicated and the machine has to be off during the cleaning procedure which is often not a viable option.

Furthermore, since most steam wands are integral to a given espresso machine, the specific length and shape of the wand is fixed, and it cannot be changed without significant effort.

A need exists for a mechanism that allows a steam wand to be easily detached from an espresso machine to provide users to quickly and easily replace the steam wand with a different steam wand.

### SUMMARY OF THE INVENTION

The present invention is about a detachable steam wand that is formed of multiple parts for a beverage making machine comprising the steam wand has a first and second portion formed or coated of heat resistant materials. wherein the first portion is preferably a steam valve or any pressure controlling unit that can be either permanently or temporarily attached to the beverage making machine. The second portion of the steam wand is a flexible hose having a discharging head or tip or outlet that can be quickly connected to the first portion when required. Further, the first and second portion can be connected by any coupling mechanism.

The coupling mechanism that helps in connecting the first and second portion can include a spherical bearing. In specific, the first portion that acts as a male securing part can include a spherical bearing and the second portion that acts as female securing part fits into the spherical bearing or vice-versa that allows the second portion to quickly connect or disconnect with the other portion of the steam wand or out of machine commissioning

It is an object of the present invention to provide effective cleaning for the steam wand without disturbing the machine operation.

In an embodiment of the invention, the coupling mechanism that helps in securing the first and second portion can be selected from pair of magnets, a magnet to metal, mechanical latching, threaded means, gears, pins or by any mechanical attachment.

Another object of the invention is to provide the first portion of the wand with the capability to accept the second portion of the wand that can be formed of varying lengths and widths, varying tips such as blade, conventional and for modified aesthetics such as color, logo, brands and thereof.

In an alternative embodiment of the invention, the steam wand can be formed of different styles and configurations such as bent, straight, S-shape, L-shape or multi-bent or curved and thereof based on the user possibility.

In an alternative embodiment of the invention, the steam wand can be used for delivering steam, hot water, textures, milk and any hot beverage based on the requirement.

In an alternative embodiment of the invention, the steam wand formed or coated of any heat resistant materials such as brass, stainless steel, copper, Teflon and thereof based on the user possible requirement of the invention.

In another embodiment of the invention, the first and second portion of the steam wand can be moved independently or as a unit for adjusting the steam wand angle and position accordingly.

In other embodiment of the invention, the first and second portion of the steam wand can use a gasket or any sealing material to prevent leaks. Further, the gasket can also be provided over the wand to prevent the accidental burns to the user during any user's unintentional contact of the steam wand.

In other embodiment of the invention, the steam wand of the beverage making machine can be any pipe, nozzle, port or tube used for delivering contents in it.

The above-described and other features and advantages realized through the techniques of the present disclosure will be better appreciated and understood with reference to the following detailed description, drawings, and appended claims. Additional features and advantages are realized through the techniques of the present invention. Other embodiments and aspects of the invention are described in detail herein and are considered a part of the claimed invention.

### BRIEF DESCRIPTION OF THE DRAWINGS

The accompanying figures and drawings, incorporated into and forming part of the specification, serve to further illustrate the present invention, its various principles and advantages, and its varying embodiments

FIG. 1 illustrates a perspective view of a first portion of the steam wand, in accordance with an embodiment of the invention;

FIG. 2 illustrates a perspective view of the second portion of the steam wand, in accordance with an embodiment of the invention;

FIG. 3 illustrates a perspective view of the first and second portion of the steam wand during assembling/connecting, in accordance with an embodiment of the invention;

FIG. 4 illustrates a perspective view of the assembled first and second portion of the steam wand, in accordance with an embodiment of the invention;

FIG. 5 illustrates the side view of beverage making machine with steam wand first portion; in accordance with an embodiment of the invention;

FIG. 6 illustrates the side view of beverage making machine with the assembled steam wand, in accordance with an embodiment of the invention;

### DETAILED DESCRIPTION

In the following description, numerous specific details are set forth to provide a thorough understanding of various embodiments. One skilled in the relevant art will recognize, however, that the techniques described herein can be practiced without one or more of the specific details, or with other methods, components, materials, etc. In other instances, well-known structures, materials or operations are not shown or described in detail to avoid obscuring certain aspects.

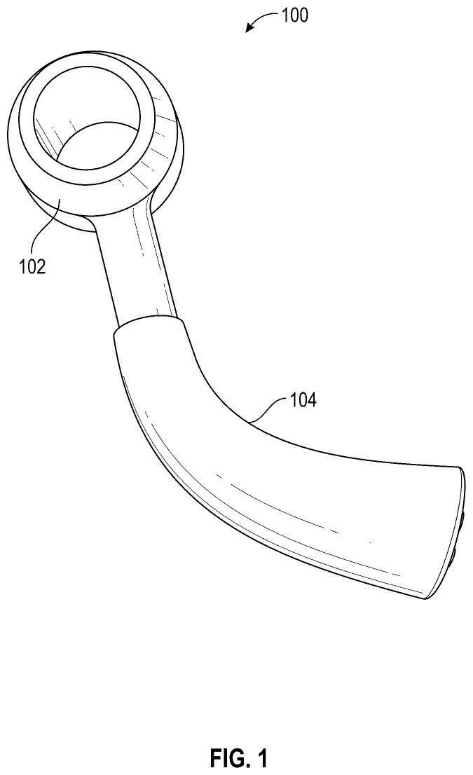

This invention relates generally to mechanics, and more specifically, to device and connection mechanism for the steam wand. Specific details of certain embodiments of the invention are set forth in the following description and in FIGS. 01-06 to provide the understanding of such embodiments. The present invention may have additional embodiments, may be practiced without one or more of the details described for any particular described embodiment, or may have any detail described for one particular embodiment practiced with any other detail described for another embodiment.

A steam wand that is formed of multiple parts namely first and second portions. FIG. 1. Illustrates a perspective view of the first portion tube 100 of the wand is generally metallic and steam passes through it. Further, the first portion tube 100 of the steam wand includes a circular portion 102 or a valve or a connecting means that is connected to the beverage brewing machine (not shown) and allows to pass the contents such as steam, hot water, milk, textures and any other liquid from the machine to enter and pass through the protruding tubular portion 104 of the wand that allows free flow of fluid/contents without any restriction can be covered with an insulating or aesthetic material such as plastic, rubber or any suitable thermal insulation material to prevent contact/human burns. The first portion 100 of the wand may be articulated or stationary by having a ball at one end that is received by a socket that forms part of the support fixture. An opposite end of the first portion 100 is provided with a coupling mechanism (not shown).

In one embodiment of the invention, the wand can be straight or bent or curved and any of any shape or configuration based on the requirement of the user.

In an alternative embodiment of the invention, the first portion 100 of the steam wand be used as valve or pressure controlling unit or a connector. Further, the required controlling mechanism for adjusting the pressure can be a button, switch or lever or touchpad or knob can be positioned in proximity or to a remote location from the circular opening 102.

In some embodiment of the invention, the first portion tube 100 can be formed of any heat resistant material with sufficient structural strength and rigidity, such as brass, copper, stainless steel, high-temperature plastic, composite, and similar, or any combination thereof.

In other embodiment of the invention, the first portion 100 of the steam wand can be either permanently or temporarily connected to the beverage making machine.

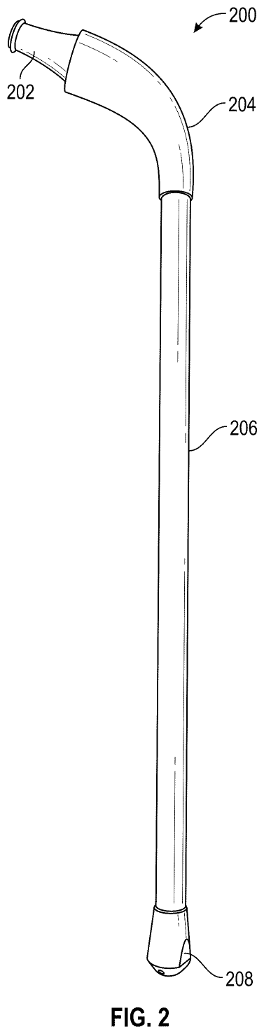

FIG. 2. Illustrates a perspective view of the second portion or a submersible wand 200 formed of a hollow tubular member 206 having a female securing part 202 and a leaning bulge portion 204. Wherein the female securing part 202 can be formed of different shapes that suitable for a quick connect or disconnect assembly. Further, the bottom of the tubular member 206 can be provided with a discharging head/tip/outlet 208.

In an embodiment of the invention, the second portion 200 can also be used as a handle to manipulate the position of the assembly as a whole.

In an embodiment of the invention the tubular member 206, female securing part 202, leaning bulge portion 204, discharging tips 208 can all be made up of the same or differing materials. Materials must be heat resistant and sufficiently strong for the purpose.

In some embodiment of the invention the female securing part 202, tubular member 206 can be provided with any sealing means such as gasket and thereof. Further tubular member 206 can also be covered with an insulating material. In an embodiment, the tubular member 206 is substantially rigid. In an embodiment, the tubular member can be a flexible hose.

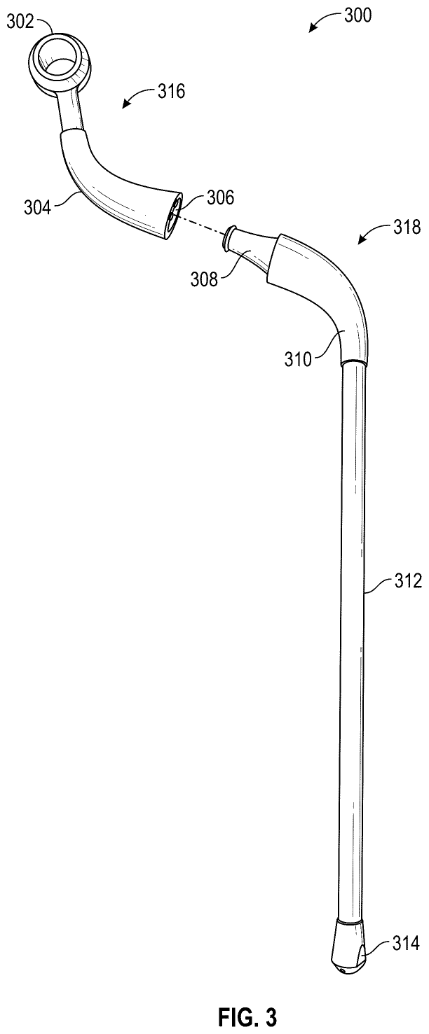

FIG. 3 illustrates a perspective view of the steam wand 300 that includes the first portion 316 and a second portion 318 during assembling/connecting. Wherein, the first portion or the connector 316 comprises of circular portion/ring or valve or connecting means 302 is connected to the beverage brewing machine (not shown) and allows to pass the contents such as steam, hot water, milk, textures and any other liquid from the machine to enter and pass through the protruding tubular portion 304. The distal end of the connector 316 includes coupling means or a male securing part 306. Wherein, the coupling means or the male securing part 306 can include spherical bearing or a slot to accept the female securing part 308 of the tubular member 312 of the submersible wand 318 and it still allows the wand to move at varying angles. Further, the tubular member 312 of the submersible wand 318 can include leaning bulge portion 310 and discharging head/tip 314.

In an embodiment of the invention, the female securing part 308 can be formed of various design that allows for quick connect or disconnecting of the submersible wand 318 with the connector 316.

In an alternative embodiment of the invention, the male connecting part 306 of the first portion or connector 316 can include at least one magnet and female connecting part 308 of the second portion or submersible wand 318 can also include at least one magnet. Wherein the male connecting part 306 of the connector 316 attracts the female connecting part 308 of the submersible wand 318 and quickly attaches/locks the submersible wand 318 to the connector/valve 316. Further, the submersible wand 318 can be quickly removed by applying appropriate pressure to separate the locking magnets (not shown). Alternatively, the magnets can be either rare-earth or ferromagnets.

In other embodiment of the invention, the male connecting part 306 can be provided with at least one magnet or ferromagnet or rare earth magnets and the female portion 308 is just formed of the metal body or vice-versa allows to quickly connect the connector 316 and submersible wand 318 quickly.

In some embodiment of the invention, the male 306 and female connecting parts 308 can be coupled through different attaching means such as latching, thread “stub” or any mechanical attaching means.

In another embodiment of the invention, the submersible wand 318 is connected to the connector 316 at any middle or intermediate position.

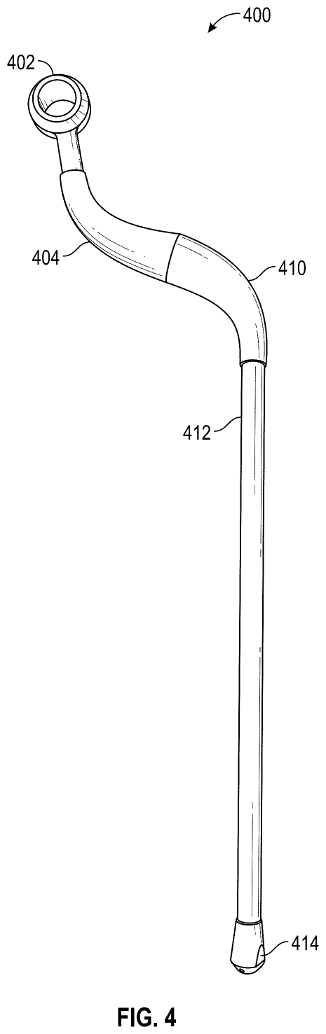

FIG. 4 illustrates a perspective view of assembled steam wand 400 that includes the first portion and the second portion after assembling. Wherein, the first portion or the connector comprises of circular portion/ring or valve or connecting means 402 is connected to the beverage brewing machine (not shown) and allows to pass the contents such as steam, hot water, milk, textures and any other liquid from the machine to enter and pass through the protruding tubular portion 404. The distal end of the connector includes coupling means or a male securing part (not shown). Wherein, the coupling means or the male securing part (not shown) can include spherical bearing or a slot to accept the female securing part (not shown) of the tubular member 412 of the submersible wand. Further, the tubular member 312 of the submersible wand can include leaning bulge portion 410 and discharging head/tip 414.

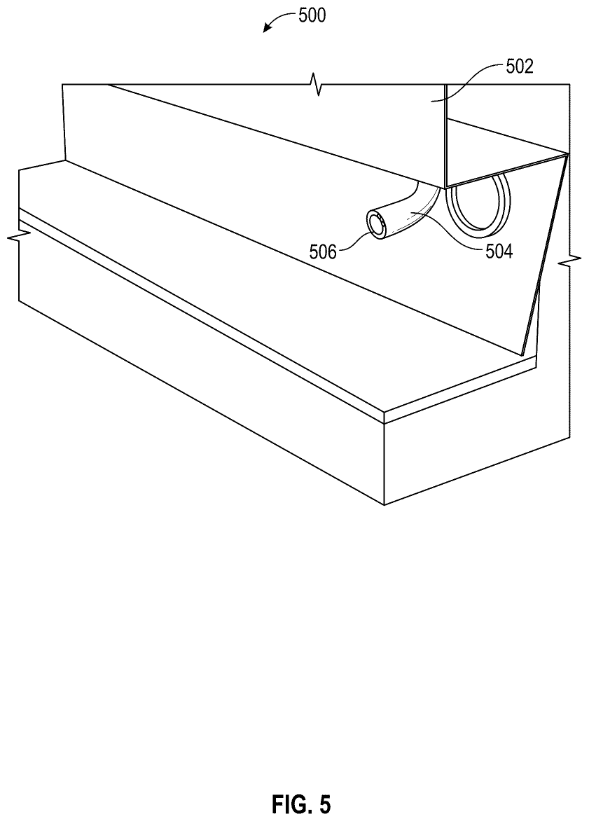

FIG. 5 illustrates the side view of the beverage making machine with a first portion or connector 500 includes a beverage making machine 502, a first portion or connector 504 proximal end is fixed to the beverage making machine 502 and the distal end of the first portion or connector 504 is provided with an engaging or coupling member 506. Wherein the first portion can be a valve or connector that is connected to the beverage brewing machine (not shown) and allows to pass the contents such as steam, hot water, milk, textures and any other liquid from the machine to enter and pass through the protruding tubular portion 504 of the wand that allows free flow of fluid/contents without any restriction can be covered with an insulating or aesthetic material such as plastic, rubber or any suitable thermal insulation material to prevent contact/human burns. The first portion of the wand may be articulated or stationary by having a ball at one end that is received by a socket that forms part of the support fixture.

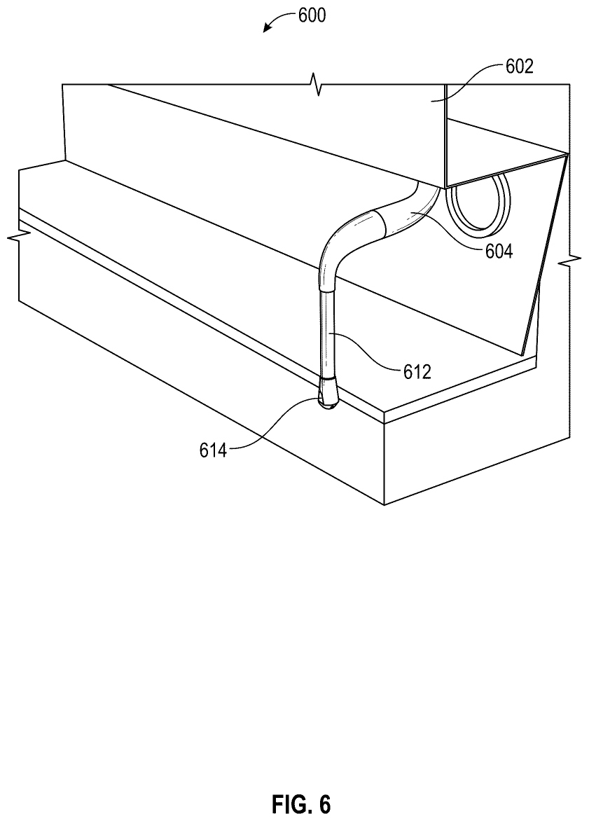

FIG. 6 illustrates the side view of the assembled/connected assembled steam wand 500 that includes the first portion (connector/valve) 604 and the second portion (hose) 612 after assembling. Wherein, the first portion 604 or the connector comprises of circular portion/ring or valve or connecting means is connected to the beverage brewing machine (602) and allows to pass the contents such as steam, hot water, milk, textures and any other liquid from the machine to enter and pass through the protruding tubular portion of the first portion or connector 604. The distal end of the connector includes coupling means or a male securing part (not shown). Wherein, the coupling means or the male securing part (not shown) can include spherical bearing or a slot to accept the female securing part (not shown) of the tubular member 612 of the submersible wand. Further, the tubular member 612 of the submersible wand can include leaning bulge portion and discharging head/tip 614.

According to any embodiment of the invention, the steam wand can be formed of different shapes or configurations such as bent, straight, S-shape, L-shape or multi-bent or curved and thereof based on the user possibility.

According to any other embodiment of the invention, the steam wand can be used for delivering steam, hot water, textures, milk and any hot beverage based on the requirement.

According to another embodiment of the invention, the steam wand formed or coated of any heat resistant material with sufficient structural strength and rigidity, such as brass, copper, stainless steel, high-temperature plastic, composite, and similar, or any combination thereof.

According to another embodiment of the invention, the steam wand can be formed of at least two parts. Further, the wand can be formed of multiple segments such as three or four according to the user requirement.

According to any embodiment of the invention, the second portion of the wand can be replaced with wands of different lengths and widths so as to match the beverage vessel such as jug, cup and thereof.

According to another embodiment of the invention, tips of the steam wand can be replaced with different tips such as blade and conventional.

According to any embodiment of the invention, the first portion or connector of the wand has the capability to accept the second portion of the wand formed of modified aesthetics such as color, logo, brands and thereof.

In another embodiment of the invention, the connector and submersible wand portion of the steam wand can be moved independently or as a unit for adjusting the steam wand angle and position accordingly.

In other embodiment of the invention, the first and second portion of the steam wand can use a gasket or any sealing material to prevent leaks. Further, the gasket can also be provided over the wand to prevent the accidental burns to the user during any user's unintentional contact of the steam wand.

In other embodiment of the invention, the steam wand of the beverage making machine can be any pipe, nozzle, port, hose or tube used for delivering contents in it. In an embodiment it the submersible wand is a substantially rigid member. In alternative embodiments, the submersible wand is a flexible tube or hose. In further embodiments, the submersible wand is a combination of rigid and flexible tube.

The steam wand allows the submersible wand or second portion to be quickly connected at an intermediate point along with the steam wand that allows the distal portion of the wand to be replaced if required.

According to any embodiment of the invention, the steam wand allows for an easier and effective way of cleaning the wand by simply disconnecting the submersible wand portion and clean the connector part and submersible wand part individually without taking the machine out of commission. Further, the submersible wand part can be sterilized if required.

Further, the submersible wand part or the second portion can be simply replaced in case of breakage or during maintenance without taking the machine out of commission.

The connector and the parts around it have high clearance ratio that allows the user to clean the out of reach areas and wash or clean it effectively.

In an embodiment of the invention, the first and second portions can be formed of same or different materials.

In an embodiment of the invention, the beverage making machine can be an espresso machine, coffee machine, cappuccino any hot beverage making machine that can be used in commercial or household purposes.

In an embodiment of the invention, the beverage making machine can still have fixed steam accessory along with detachable wands.

Thus, the present invention is well adapted to carry out the objects and attain the ends and advantages mentioned as well as those inherent therein. While preferred embodiments of the present invention have been illustrated for the purpose of the present disclosure, changes in the arrangement and construction of parts and the performance of steps can be made by those skilled in the art, which changes are encompassed within the scope and spirit of the present invention as defined by the appended claims.

I claim:

1. A detachable steam wand apparatus comprising:
a first portion of the steam wand having a proximal end and a distal end, the proximal end of the first portion is connected to a beverage making machine that provides a source of pressurized stream, the first portion being formed of a heat resistant material,
a second portion of the steam wand having a proximal end and a distal end, the proximal end of the second portion is removably attachable to the distal end of the first portion; the distal end of said second portion terminates in a discharging tip, the second portion being formed of heat resistant material, and
the second portion is removably attachable to the first portion by a coupling mechanism.

2. The steam wand apparatus of claim 1, wherein the first portion of the steam wand can be a valve or any steam controlling unit that can be either permanently or temporarily connected to the beverage making machine.

3. The steam wand apparatus of claim 1, wherein the second portion of the steam wand is a flexible hose.

4. The steam wand apparatus of claim 1, wherein the coupling mechanism uses magnetic attraction to provide a coupling force.

5. The steam wand apparatus of claim 1, wherein the coupling mechanism a mechanical latching mechanism to provide a coupling force.

6. The steam wand apparatus of claim 1, wherein the wand can be used for delivering steam or hot water.

7. The steam wand apparatus of claim 1, wherein the second portion of the steam can be detachable for effective cleaning without taking the steam source out of commission.

8. The steam wand apparatus of claim 1, wherein the first and second portion of the steam wand can move either independently or as a unit for adjusting the steam wand angle and position.

9. The steam wand apparatus of claim 1, wherein the second portion is attached to the first portion via a spherical bearing.

10. The steam wand apparatus of claim 1, wherein at least one of the first and second portion can have a gasket for sealing.

11. The steam wand apparatus of claim 1, wherein the first portion of the wand has the capability to accept the second portion of the wand formed of varying lengths, varying tips, and modified aesthetics.

12. The steam wand apparatus of claim 1, wherein the beverage making machine can be an espresso machine, coffee machine, cappuccino, or any hot beverage making machine.

13. The steam wand apparatus of claim 1, wherein the second portion of the steam wand can be quickly connected at an intermediate point along with the steam wand that allows the distal portion of the wand to be replaced if required.

14. The steam wand apparatus of claim 1, wherein the first and second portion attachment area mate using a gasket.

15. A quick connect steam wand apparatus for an espresso machine, the quick connect steam wand comprising:
a steam wand for delivering steam having proximal and distal portions that are separable from each other; wherein the proximal portion of the wand has a first end and second end; wherein the first end is connected to the espresso machine;
the distal portion of the wand is connected to the second end of the proximal portion by means of the coupling mechanism.
